(19) United States
(12) Patent Application Publication
(10) Pub. No.: US 2022/0073763 A1
(43) Pub. Date: Mar. 10, 2022

(54) NOVEL BIOBASED POLYESTER

(71) Applicant: SWIMC LLC, Cleveland, OH (US)

(72) Inventor: Thomas J. Melnyk, Cleveland, OH (US)

(21) Appl. No.: 17/455,279

(22) Filed: Nov. 17, 2021

Related U.S. Application Data
(63) Continuation of application No. 15/874,925, filed on Jan. 19, 2018, now abandoned.
(60) Provisional application No. 62/194,901, filed on Jul. 21, 2015.

(51) Int. Cl. C09D 7/61; C08K 3/22; C09D 167/02; C08J 3/24; C08L 67/02

(52) U.S. Cl. CPC C09D 7/61; C08K 3/22; C08G 63/553; C08J 3/24; C08L 67/02; C09D 167/02

(57) ABSTRACT

A novel linear polyester resin is made by condensation of one or more aliphatic or cycloaliphatic polyols with one or more aliphatic or cycloaliphatic polyfunctional acids derived from biobased materials or a biological feedstock. Coating compositions and coated substrates using the novel linear polyester resin are also described.

### CROSS-REFERENCE TO RELATED APPLICATION(S)

This application claims priority from U.S. Provisional Application No. 62/194,901 filed 21 Jul. 2015 and entitled “Novel Biobased Polyester,” incorporated herein by reference in its entirety.

### BACKGROUND OF THE INVENTION

High solids polyester resins are used in a wide variety of industrial liquid applications. Conventional polyesters of this type include alkyds, low molecular weight oligoester systems and highly branched or dendritic polyester systems.

Environmental concerns over waste, sustainability and the rising costs of raw materials derived from petroleum sources have created a global need to make polymers and resins from renewable and environmentally friendly biobased or biologically derived feedstock. For example, alkyd resins and other polyesters derived from waste materials and recycled feedstock are used to make “green” coating compositions for various applications. Therefore, used cooking oil, called yellow grease or brown grease, is typically trapped and filtered out of waste water streams and rendered into animal feed, biodiesel fuel and the like. In addition, waste cooking oil may be used as a fatty acid feedstock for producing alkyd resins, although these alkyd resins may lack the hardness, durability and early water resistance required of a water-reducible coating composition.

However, existing high solids alkyd and polyester systems may lack the hardness, durability and weatherability of conventional industrial coatings, and the relatively low molecular weight of polyesters used in conventional high solids systems leads to products with poor mechanical properties. Moreover, conventional polyester systems when used in coil lines sometimes produce oven fouling where low molecular weight residues of the polyester are formed during the coil process and condense back onto the coated substrate.

From the foregoing, it will be appreciated that what is needed in the art is a high solids polyester coating composition that is made from biobased renewable feedstock and has optimal mechanical properties and performance while also eliminating specific processing concerns.

### SUMMARY

In one embodiment, the present disclosure provides a coating composition that includes a binder that comprises a linear polyester resin having number average molecular weight (Mn) of at least about 1000, hydroxyl equivalent weight of at least about 1000 mg KOH per gram, and less than about 5 percent by weight aromatic groups; and optionally, a curing agent capable of reacting with the linear polyester resin to produce a crosslinked polymeric network. The coating composition also includes at least one pigment.

In another embodiment, the present disclosure provides a coated article that includes a substrate with a cured coating applied thereon. The cured coating is derived from a coating composition. In a preferred aspect, the coating composition includes a binder that comprises a linear polyester resin having number average molecular weight (Mn) of at least about 1000, hydroxyl equivalent weight of at least about 1000 mg KOH per gram, and less than about 5 percent by weight aromatic groups; and optionally, a curing agent capable of reacting with the linear polyester resin to produce a crosslinked polymeric network. The coating composition also includes at least one pigment.

In yet another embodiment, the present disclosure also provides methods of preparing coated articles using the coating composition described herein.

The above summary of the present invention is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

The details of one or more embodiments of the invention are set for in the accompanying drawings and the description below. Other features, objects, and advantages of the invention will be apparent from the description and drawings, and from the claims.

### Selected Definitions

Unless otherwise specified, the following terms as used herein have the meanings as provided below.

As used herein, the term “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups). The term “aliphatic group” means a saturated or unsaturated linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, t-butyl, heptyl, dodecyl, octadecyl, amyl, 2-ethylhexyl, and the like. The term “alkenyl group” means an unsaturated, linear or branched hydrocarbon group with one or more carbon-carbon double bonds, such as a vinyl group. The term “alkynyl group” means an unsaturated, linear or branched hydrocarbon group with one or more carbon-carbon triple bonds. The term “cyclic group” means a closed ring hydrocarbon group that is classified as an alicyclic group or an aromatic group, both of which can include heteroatoms. The term “alicyclic group” means a cyclic hydrocarbon group having properties resembling those of aliphatic groups. The term “cycloaliphatic” is used interchangeably with “alicyclic group” herein.

A group that may be the same or different is referred to as being “independently” something. Substitution is anticipated on the organic groups of the compounds of the present invention. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc.

The term “component” refers to any compound that includes a particular feature or structure. Examples of components include compounds, monomers, oligomers, polymers, and organic groups contained there.

The term “substantially free” of a particular compound or component means that the compositions of the present invention contain less than 5 percent by weight of the compound or component based on the total weight of the composition.

Unless otherwise indicated, a reference to a “(meth)acrylate” compound (where “meth” is bracketed) is meant to include both acrylate and methacrylate compounds.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

The term “volatile organic compound” (“VOC”) refers to any compound of carbon, excluding carbon monoxide, carbon dioxide, carbonic acid, metallic carbides or carbonates, and ammonium carbonate, which participates in atmospheric photochemical reactions. Typically, volatile organic compounds have a vapor pressure equal to or greater than 0.1 mm Hg. As used herein, “volatile organic compound content” (“VOC content”) means the weight of VOC per volume of the coating solids, and is reported, for example, as kilograms (kg) of VOC per liter.

Unless otherwise indicated, the term “polymer” includes both homopolymers and copolymers (i.e., polymers of two or more different monomers).

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

The present description provides coating compositions including one or more novel polyesters. The coating composition includes a binder resin and optionally, at least one pigment. The binder resin includes a novel polyester, an optional crosslinker and other optional additives that are conventionally used in coating compositions. The present description also provides coated articles that comprise a substrate coated with the coating composition described herein.

In one embodiment, the novel polyester described herein may be formed from compounds having reactive functional groups, including for example, hydroxyl, acid, anhydride, acyl, and ester functional groups and the like. Under proper conditions, compounds having reactive hydroxyl functional groups may react with acid, anhydride, acyl or ester groups to form a polyester. Suitable compounds for forming polyesters include mono-, di-, and polyfunctional compounds, with difunctional compounds preferred. In an aspect, suitable compounds include those having reactive functional groups of a single type, such mono-, di- and polyfunctional alcohols, or mono-, di-, and polyfunctional acids, for example. In another aspect, suitable compounds include those with two or more types of reactive functional groups such as a compound with anhydride and acid functionality or a compound with acid and hydroxyl functionality, for example.

In one embodiment, the novel polyester described herein may be a linear polyester. By “linear polyester” is meant one or more condensation polymers that may be formed by condensation of at least one mono-, di-, or polyfunctional hydroxyl functional compounds (e.g. polyol) with one or more mono-, di-, or polyfunctional carboxyl functional compounds (e.g. acids, anhydrides, and the like). In an aspect, the linear polyester described herein is a condensation polymer formed by condensation of a difunctional alcohol with a difunctional acid.

In one embodiment, the novel linear polyester described herein is prepared by condensation of an aliphatic or cycloaliphatic acid, ester, or anhydride with a suitable polyol. Suitable difunctional aliphatic acids, esters, or anhydrides include compounds having the structure shown in Formula (I);

R₁O—C(═O)-(A)ₙ-C(═O)—OR₂ (I)

In Formula (I), R₁ and R₂ are each independently H, unsubstituted or substituted C1-C6 alkyl, or unsubstituted or substituted C2-C6 alkylene, A is a divalent organic group of formula unsubstituted or substituted C1-C10 alkyl, unsubstituted or substituted C2-C10 alkylene, or unsubstituted or substituted C3-C10 cycloalkyl; and n is an integer between 1 and 20. In a preferred aspect, R₁ and R₂ are each independently H, A is —CH₂—, and n is an integer between 2 and 4.

Examples of difunctional aliphatic acids, esters or anhydrides of Formula (I) include, without limitation, succinic acid, glutaric acid, adipic acid, pimelic acid, suberic acid, azelaic acid, sebacic acid, diglycolic acid, maleic acid, maleic anhydride, fumaric acid, itaconic acid, dimer fatty acids, malic acid, esters of these acids, and the like. In a preferred aspect, the difunctional aliphatic acid is succinic acid or adipic acid, with succinic acid most preferred.

In one embodiment, the difunctional aliphatic acid used to form the linear polyester described herein is derived from biobased materials, i.e. materials or products derived from or made using biological raw materials. Such materials are renewable and are typically obtained from or produced by living organisms such as, for example, plants, trees, algae, bacteria, yeast, fungi, protozoa, insects, animals, and the like. Processes for obtaining diacids from such biomaterials are known to those of skill in the art. For example, many organic acids including, without limitation, fumaric acid, malic acid, succinic acid, and the like, may be obtained by anaerobic fermentation of various types of baceteria and/or mold. Biobased or bioderived difunctional acids are preferred because of a lower ecological footprint associated with production and use of such materials.

Examples of difunctional cycloaliphatic acids, esters or anhydrides of Formula (I) include, without limitation, 1,2-, 1,3-, and 1,4-cyclohexanedicarboxylic acid and their methyl esters, hexahydrophthalic anhydride (HHPA), and the like.

Suitable polyols for preparing the novel polyesters described herein include aliphatic and cycloaliphatic polyols, with aliphatic polyols preferred. Examples of suitable aliphatic polyols include, without limitation, diols such as 1,6-hexanediol, pentaerythritol, trimethylolpropane, 2-methyl-1,3-propanediol, neopentyl glycol, 2-butyl-2-ethyl-1,3-propanediol, ethylene glycol, propylene glycol, 1,4-butanediol, 1,3-butanediol, 1,5-pentanediol, tetramethyl pentanediol (TMPD), trimethylol ethane, 3-hydroxy-2,2-dimethylpropyl 3-hydroxy-2,2-dimethylpropionate (HPHP), etc. Presently preferred compounds include 2-methyl-1,3-propanediol, neopentyl glycol, and TMPD, with TMPD most preferred.

Examples of suitable cycloaliphatic polyols include, without limitation, 1,2-, 1,3-, and 1,4-cyclohexanediol, 1,2-, 1,3-, and 1,4-cyclohexanedimethanol, hydrogenated bisphenol A, etc.

Although difunctional aromatic acids, esters and anhydrides may be used to prepare polyesters, the amount of aromatic compounds should be limited. Without limiting to theory, it is believed that aromatic compounds may detract from the weathering stability, reflectivity and other performance attributes of a coating composition containing a binder resin that includes the linear polyester described herein.

Similarly, aromatic polyols should be used only in limited quantities, as these compounds may have a negative impact on the physical and performance attributes of the ultimate coating composition containing a binder than includes the linear polyester described herein.

Accordingly, the linear polyester described herein includes less than about 20, preferably less than 15, more preferably less than 10, and most preferably less than 5 percent by weight of aromatic groups. Preferably, the binder resin that includes the linear polyester resin includes less than 40, preferably less than 30, more preferably less than 20, and most preferably less than 10 percent by weight of aromatic groups.

The novel linear polyester described herein has high hydroxyl equivalent weight relative to other polyesters known in the art. Preferred linear polyesters as described herein have hydroxyl numbers of from about 500 to 2500, more preferably 1000 to 2000, most preferably 1200 to 1600. Preferred linear polyesters as described herein have acid numbers from about 2 to 20, preferably about 5 to 10.

The number average molecular weight (Mn) of the linear polyester described herein suitably may range from about 1000 to 10,000, preferably from about 1500 to 6000, more preferably from about 3000 to 5000.

The novel linear polyester described herein has higher Tg relative to other polyesters known in the art. Preferred linear polyesters as described herein have Tg of about −30° C. to 20° C., preferably −20° C. to 10° C., more preferably −10° C. to 0° C.

The novel linear polyester described herein has low solution viscosity relative to other polyesters known in the art. Preferred linear polyesters demonstrate solution viscosities of less than about 10,000 cps, preferably less than about 5000, and more preferably between about 4000 and 5000 cps (approximately Z3 on the Gardner-Holt viscosity scale).

The linear polyesters described herein may be made by any of the conventional processes, preferably with the use of a catalyst as well as passage of an inert gas through the reaction mixture. Esterification takes place almost quantitatively and may be monitored by determining the acid and/or hydroxyl numbers or by monitoring the Gardner-Holt viscosity of the product.

The polyesters described herein are typically made up in organic solvents, such as 1-methoxy-2-propanol acetate, cyclohexanone, xylene, high boiling aromatic solvents such as AROMATIC 100, AROMATIC 150, and the like, and mixtures thereof.

The linear polyester described herein is included in a binder that may be formulated into a coating composition. In one embodiment, the binder may further comprise an optional crosslinker compound. The crosslinker may be used to facilitate cure of the coating and to build desired physical properties. Suitable crosslinkers include aromatic and non-aromatic crosslinkers. Again, for the reasons previously discussed, it is presently believed that limiting the total amount of aromaticity in the coating will provide coatings with the highest reflectivity. For that reason, it is expected that a non-aromatic crosslinker is preferred over an aromatic crosslinker when all other considerations are equal.

Polyesters having hydroxyl groups are curable through the hydroxyl groups, e.g., (i) with aminoplasts, which are oligomers that are the reaction products of aldehydes, particularly formaldehyde, or (ii) with amino- or amido-group-carrying substances exemplified by melamine, urea, dicyandiamide, benzoguanamine and glycoluril, or (iii) with blocked isocyanates. Hydroxyl cross-linking agents are well known to those of skill in the art.

Suitable crosslinkers include aminoplasts, which are modified with alkanols having from one to four carbon atoms. It is suitable in many instances to employ precursors of aminoplasts such as hexamethylol melamine, dimethylol urea, hexamethoxymethyl melamine, and the etherified forms of the others. Thus, a wide variety of commercially available aminoplasts and their precursors can be used for combining with the polyesters. Suitable amino crosslinking agents include those sold by Cytek under the trademark CYMEL (e.g., CYMEL 301, CYMEL 303, and CYMEL 385 alkylated melamine-formaldehyde resins, or mixtures or such resin, are useful) or by Solutia under the trademark RESIMENE. Hydroxyl-reactive cross-linking is generally provided in an amount sufficient to react with at least one-half the hydroxyl groups of the polyester, i.e., be present at at least one-half the stoichiometric equivalent of the hydroxyl functionality. Preferably, the cross-linking agent is sufficient to substantially react with all of the hydroxyl functionality of the polyester, and cross-linking agents having nitrogen cross-linking functionality are provided in amounts of from about 2 to about 12 equivalents of nitrogen cross-linking functionality per equivalent of hydroxyl functionality of the polyester. This typically translates to an aminoplast being provided at between about 10 and about 70 phr.

Suitable crosslinkers also include blocked isocyanates. U.S. Pat. No. 5,246,557 describes some suitable blocked isocyanates. Blocked isocyanates are isocyanates in which each isocyanate group has reacted with a protecting or blocking agent to form a derivative which will dissociate on heating to remove the protecting or blocking agent and release the reactive isocyanate group. Compounds already known and used as blocking agents for polyisocyanates include aliphatic, cycloaliphatic or aralkyl monohydric alcohols, hydroxylamines and ketoximes. Preferred blocked polyisocyanates dissociate at temperatures of around 160° C. or lower. Lower dissociation temperatures are desirable (assuming the coating is still stable at ambient temperatures) for energy savings reasons and where heat sensitive materials are being utilized. The presence of a catalyst is preferred in order to increase the rate of reaction between the liberated polyisocyanate and the active hydrogen containing compound. The catalyst can be any catalyst known in the art, e.g. dibutyl tin dilaurate or triethylene diamine.

Preferred linear polyesters as described herein are high solids polyesters. In a preferred aspect, the linear polyesters are TMPD-succinate polyesters prepared by the condensation of TMPD with succinic acid. These polyesters demonstrate high molecular weight (Mn), high Tg, and surprisingly low solution viscosities relative to conventional high solids polyester systems used in industrial liquid coatings applications.

Conventionally, high solids polyester systems involve two types of compositions. The first type includes slightly branched oligoesters with low molecular weight (Mn) of about 750 to 1000. These oligoesters are then formulated to achieve a high percentage of non-volatile material content (NVM %) of about 80 to 90%, high solution viscosities from about 5,000 to 10,000 cps and Tg values of below −10° C. Due to the relatively low molecular weight and low Tg, these materials provide poor mechanical performance when used in coating compositions. TMPD is often used in resins that include these oligoesters as it provides excellent physical properties, including improved flow and leveling. However, the presence of a sterically hindered secondary hydroxyl groups makes it difficult to achieve higher molecular weights (i.e. Mn>1500) without decomposition of the molecule.

The second type of high solids polyester system includes dendritic or hyperbranched polyesters. Dendritic polyesters are characterized by densely branched structures and a large number of reactive end groups. These polyesters are obtained by polymerization of AB2 monomers, resulting in branched structures that demonstrate exponential growth in both molecular weight and end-group functionality. Using a controlled stepwise synthesis with an AB2 polyol such as dimethylpropionic acid (DMPA), it is possible to produce hyperbranched resin with higher molecular weights (Mn of 3000 or more) with low solution viscosities of 5000 cps or less, while having NVM % and Tg values comparable to the oligoesters described above. However, these hyperbranched polymers produce coatings with poor fabrication properties due to the high end-group functionality and their highly branched architecture. Moreover, DMPA is an expensive material and hyperbranched dendrimer polyesters are often prohibitively costly.

Surprisingly, the linear polyesters described herein, such as the polyesters formed by the reaction of TMPD and succinic acid, for example, can achieve the higher molecular weights (Mn>3000 or more) with low solution viscosities and higher Tg comparable to the hyperbranched dendritic polyesters. In addition, the highly linear, low functional structure of these polyesters produces coatings with superior mechanical properties as compared to both the oligoester and dendritic polymer approaches.

The linear polyesters described herein may be included in a binder that may be formulated into a coating composition. In one embodiment, in addition to the polyester resin and optional crosslinker compound, the coating composition may contain up to about 60 wt. percent pigments and optional fillers.

Suitably, the pigment:binder weight ratio is at least 0.9:1, more preferably at least 0.95:1 and most preferably at least 1:1. In preferred embodiment, the pigment:binder weight ratio does not exceed about 1.4:1.

TiO₂ is a preferred pigment for the high reflectivity coatings of the present invention. A wide variety of TiO₂ fillers are suitable. It is presently preferred to utilize rutile TiO₂. If desired, the TiO₂ may be surface treated. The surface treatment used may be chosen to fit the particular purpose of the coating. For example, a coating made for an interior application may use a different treatment than one designed for exterior usage.

Other additives known in the art, such as flow modifiers, viscosity modifiers and other binders may be dispersed in the coating composition. A catalytic amount of a strong acid (e.g., p-toluenesulfonic acid) may be added to the composition to hasten the cross-linking reaction.

As previously mentioned, the coating composition may further comprise one or more carriers (e.g., solvents). Suitable carriers include 1-methyoxy-2-propanol acetate, cyclohexanone, xylene, alcohol (e.g., butanol), high boiling aromatic solvents, such as AROMATIC 100, 150 and 200, etc., and mixtures thereof.

The coating composition thus obtained may be applied to a variety of different substrates. Exemplary substrate materials include metals, metal alloys, intermetallic compositions, metal-containing composites, combinations of these, and the like. The coating compositions can be applied on new substrates or can be used to refurbish old substrates.

In one embodiment, the coating composition thus obtained may be applied to sheet metal for a variety of end uses, such as, for example, lighting fixtures; architectural metal skins, e.g., gutter stock, window blinds, siding and window frames; and the like, by spraying, dipping, or brushing but is particularly suited for a coil coating operation wherein the composition is wiped onto the sheet as it unwinds from a coil and then baked as the sheet travels toward an uptake coil winder.

Examples of other uses for the coating composition include, without limitation, as coatings applied to natural materials, building materials, trucks, railcars, freight containers, flooring materials, walls, furniture, other building materials, motor vehicle components, aircraft components, marine components, machinery components, laminates, equipment components, appliances, packaging, and the like.

In one embodiment, the coating composition may be used to produce a highly reflective coating. Without limiting to theory, the use of cycloaliphatic groups in the backbone of a polymer is believed to contribute to increased reflectivity, as described in U.S. Pat. No. 7,244,506, for example. With regard to reflectivity, the use of a cycloaliphatic group containing compound in place of an aromatic group containing compound results in a lower refractive index for the cured binder. The linear polyesters described herein are devoid of aromatic groups but maintain Tg values of greater than −10° C. and offer the same benefit of improved reflectivity at a much lower cost than polyesters with cycloaliphatic acids or anhydrides in the backbone.

In another embodiment, the coating composition may be used to produce a superdurable polyester. It is believed that the use of cycloaliphatic and aliphatic groups in the backbone of a polymer contributes to UV stability, implicated in outdoor weathering. This is attributable to aliphatic and cycloaliphatic groups being transparent to light at certain wavelengths, i.e. about 290 to 310 nm. The absence of aromatic groups in the linear polyesters described herein contributes to excellent UV stability, particularly when tested in accelerated QUV-A cabinets.

In one embodiment, the coating composition described herein can be used as a high solids polyester for low isocyanate 2K polyurethane systems. Conventionally, in order to meet low VOC requirements, 2K polyurethane coating systems typically use low molecular weight (Mn of approximately 1000) polyesters with corresponding low OH equivalent weights (approximately 300 to 4000 mg KOH/g). To maximize coating performance, the coating systems typically use a stoichiometric equivalent concentration of isocyanate crosslinker. Using conventional polyols of low OH equivalent weights, the isocyanate demand tends to be both high and prohibitively expensive. By using the linear polyesters described herein, it is possible to formulate a high solids coating composition with comparable solution viscosities to conventional high solids systems but with OH equivalent weights in the 1200-1600 range with Tg values higher than −10° C. Such 2K coatings require 50% or less isocyanate than conventional systems with comparable physical and mechanical performance characteristics

In one embodiment, the coating composition may be used as a coating, especially a coil coating, used to coat the back side of an aluminum or steel sheet, also known as coil backer coatings. Conventionally, to meet low VOC requirements, the industry has relied on low molecular weight, high solids alkyd and polyester resins. However, when oligomeric polyesters are used in high speed, induction-heated coil lines, oven fouling is observed. Fouling manifests itself as a low molecular weight residue that condenses in the oven and subsequently drips back onto the coated substrate. This is a serious problem that reduces the utility of these polyester systems. The linear polyesters described herein have comparable solution viscosities as conventional high solid alkyd and polyester resins, but two- to three times the molecular weight. Accordingly, it is possible to use these polyester resins in coating compositions for use as coil backer coatings while maintaining low VOC and significantly reducing oven fouling problems.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight. Unless otherwise specified, all chemicals used are commercially available from, for example, Sigma-Aldrich, St. Louis, Mo.

### Example 1. Preparation of TMPD-Succinate Polyester Resin

541 grams of TMPD, 22 grams of glycerin, 438 grams of succinic acid, and 1.0 gram of butyl stannoic acid were charged to a 2.0 liter flask equipped with an agitator, packed column, condenser, thermometer, and inert gas inlet. The reaction flask was flushed with inert gas and the contents heated to 210° C. over a 6 hour period while removing water. The batch temperature was held at 210° C. until an acid number less than 30 was achieved. The packed column was removed and replaced by a Dean Stark trap. 26 grams of xylene were introduced into the reactor to facilitate azeotropic removal of water. The reaction was held at 210° C. until an acid number of less than 20 was achieved. The batch was cooled to 180° C. and 164 grams of Aromatic 100 were added to the reaction flask.

A polyester product with final acid number of 15 and final Tg of −7.7° C. is obtained. The final viscosity measured as an 80% solution in Aromatic 100 was Z3 (Gardner-Holt). The color as measured on the Gardner scales was 1.

### Example 2. Comparison of TMPD-Succinate Polyester to Conventional Polyester

Table 1 demonstrates the difference in key physical properties between a linear polyester made according to Example 1 (TMPD-SA) and other conventional high solids polyester systems and dendritic polyester systems.

TABLE 1
TMPD-Succinate Polyester versus Conventional
and Dendritic Polyesters

| | TMPD/SA | Coil Backer | Polyurethane | Dendritic Polyol |
|---|---|---|---|---|
| Mn | 3700 | 730 | 721 | 3400 |
| Viscosity | Z3 | Z3-Z5 | Z3-Z5 | — |
| % NVM | 80 | 84 | 83 | 90 |
| OH Eq. Wt. | 1250 | 390 | 372 | 282 |
| Tg° C. | −7.7 | −12.7 | −10.5 | −36.0 |

### Example 3. Comparison of Various Diol Succinates

Table 2 compares the Tg values of various diol succinates with the linear polyester (TMPD succinate) made according to Example 1.

TABLE 2
Tg Comparison of Various Diol Succinates

| Diol | Tg° C. |
|---|---|
| Neopentyl Glycol | −17.0 |
| Propylene Glycol | −11.3 |
| 1,4 CHDM | −9.4 |
| Tetramethylpentane diol (TMPD) | −7.7 |
| 2,2,4,4 Tetramethyl-1,3 cyclobutanediol | 18.0 |
| (TMCD) | |
| Tricyclodecane dimethanol (TCDM) | 15.9 |

### Example 4. Comparison of Various Diol Succinates

Table 3 compares TMPD-succinate prepared according to Example 1 with TMPD-adipate, a linear polyester prepared by condensation of adipic acid with TMPD using a process similar to Example 1.

TABLE 3
Tg Comparison of TMPD Succinate versus TMPD Adipate

| Aliphatic Diacid | Tg° C. |
|---|---|
| Succinic | −7.7 |
| Adipic | −39.3 |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1. A coating composition, comprising:
a binder comprising
a linear polyester resin having number average molecular weight (Mn) of at least about 1000, hydroxyl equivalent weight of at least about 1000 mg KOH per gram, and less than about 5 percent by weight aromatic groups; and
optionally, a curing agent capable of reacting with the linear polyester resin to produce a crosslinked polymeric network; and
at least one pigment.

2. The composition of claim 1, wherein the linear polyester resin has Mn of about 1500 to about 6000.

3. The composition of claim 1, wherein the linear polyester resin has Mn of about 3000 to about 5000.

4. The composition of claim 1, wherein the linear polyester resin is substantially free of aromatic groups.

5. The composition of claim 1, wherein the linear polyester resin is substantially free of cycloaliphatic groups.

6. The composition of claim 1, wherein the linear polyester resin has hydroxyl number of about 1000 to 2000 mg KOH per gram.

7. The composition of claim 1, wherein the linear polyester resin has hydroxyl number of about 1200 to 1600 mg KOH per gram.

8. The composition of claim 1, wherein the linear polyester resin is derived from the reaction of an aliphatic diol with an aliphatic diacid.

9. The composition of claim 6, wherein the aliphatic diol is tetramethylpentanediol.

10. The composition of claim 8, wherein the aliphatic diacid has a structure of a compound of Formula (I):
R₁O—C(═O)-(A)ₙ-C(═O)—OR₂ (I)
wherein
R1 and R2 are each independently H, C1-C6 alkyl, or C2-C6 alkylene;
A is a divalent organic group of formula C1-C10 alkyl, C2-C10 alkylene, or C3-C10 cycloalkyl; and
n is an integer between 1 and 20.

11. The composition of claim 10, wherein R1 and R2 are each independently H, A is —CH₂— and n is a number between 2 and 4.

12. The composition of claim 10, wherein the aliphatic diacid of Formula I is succinic acid.

13. The composition of claim 10, wherein the aliphatic diacid is derived from bio-based material.

14. The composition of claim 12, wherein the aliphatic diacid is succinic acid.

15. The composition of claim 1, wherein the linear polyester resin has Tg of greater than −10° C.

16. The composition of claim 1, wherein the linear polyester resin has Tg of about −30° C. to about 20° C.

17. The composition of claim 1, wherein the linear polyester resin has low solution viscosity.

18. The composition of claim 17, wherein the linear polyester resin has low solution viscosity of about 4000 to 5000 cps.

19. A method of making a coated article, comprising:
providing a substrate;
applying to the substrate a coating composition comprising
a binder comprising
a linear polyester resin having number average molecular weight (Mn) of at least about 1000, hydroxyl equivalent weight of at least 1000 mg KOH per gram, and less than 5 percent by weight aromatic groups; and
optionally, a curing agent capable of reacting with the linear polyester resin to produce a crosslinked polymeric network; and
at least one pigment; and
curing the coating composition on the substrate to provide the coated article.

20. A coated article, comprising:
a substrate; and
a cured coating formed on the substrate, wherein the cured coating is formed from a coating composition comprising
a binder comprising
a linear polyester resin having number average molecular weight (Mn) of at least about 1000, hydroxyl equivalent weight of at least 1000 mg KOH per gram, and less than 5 percent by weight aromatic groups; and
optionally, a curing agent capable of reacting with the linear polyester resin to produce a crosslinked polymeric network; and
at least one pigment.
